(19) United States
(12) Patent Application Publication
(10) Pub. No.: US 2001/0042373 A1
(43) Pub. Date: Nov. 22, 2001

(54) Apparatus and method for throttling a heat engine

(76) Inventors: Wayne T. Bliesner, Bothell, WA (US); Gerald R. Fargo, Woodinville, WA (US)

Correspondence Address: DOWREY & ASSOCIATES, 10329 TROMBLEY ROAD, SNOHOMISH, WA, 98033, US

(21) Appl. No.: 09/911,964

(22) Filed: Jul. 23, 2001

Related U.S. Application Data
(63) Continuation-in-part of application No. 09/500,185, filed on Feb. 7, 2000, now Pat. No. 6,263,671.
Application No. 09/500,185 is a continuation-in-part of application No. 08/971,235, filed on Nov. 15, 1997, now Pat. No. 6,041,598.

(51) Int. Cl. F02G 1/04; F01B 29/10

(52) U.S. Cl. 60/517; 60/526

(57) ABSTRACT

A apparatus and method for throttling a heat engine uses a plurality of cylinder ports through a side portion of the cylinder and a sleeve that selectively opens or closes them to provide fluid communication between an interior portion of the cylinder and a reservoir area when a piston in the cylinder is below the cylinder ports. The sleeve has a plurality of throttle ports through it and moves to communicate a number of the throttle ports with a number of the cylinder ports, thereby opening the cylinder ports. Cylinder ports and throttle ports may be arranged so that as the sleeve is rotated, an increasing number of cylinder ports are opened higher up the cylinder. The cylinder ports may also be arranged so that rotating the sleeve varies the amount ports are opened. The sleeve is preferably worm-gear driven for accurate position control. Upon closing the throttle, normal operating pressures are restored via use of a check valve.

### CROSS REFERENCE TO RELATED APPLICATIONS

This application claims the benefit, under 35 U.S.C. 120 of U.S. patent application Ser. No. 09/500,185, filed Feb. 7, 2000, pending.

### BACKGROUND OF INVENTION

This application is a continuation-in-part application of pending U.S. patent application Ser. No. 09/500,185 filed on Feb. 7, 2000 (Now U.S. Pat. No. 6,263,671), which is a continuation-in-part of U.S. patent application Ser. No. 08/971,235 filed on Nov. 15, 1997 (Now U.S. Pat. No. 6,041,598). The above referenced patent applications are hereby incorporated herein by reference.

1. Field of the Invention

The present invention relates, generally, to heat engines. More particularly, the invention relates to Stirling cycle heat engines with a cylinder containing a working fluid and a piston moving therein.

2. Background Information

The maximum Stirling engine efficiency is related to the Carnot efficiency which is governed by the ratio of maximum working fluid temperature relative to the minimum fluid temperature. Improvements in technologies which increase the margin between the two temperature extremes is beneficial in terms of total cycle efficiency. The lower working fluid temperature is typically governed by the surrounding air or water temperature; which is used as a cooling source. The main area of improvements result from an increase in the maximum working temperature. The maximum temperature is governed by the materials which are used for typical Stirling engines. The materials, typically high strength Stainless Steel alloys, are exposed to both high temperature and high pressure. The high pressure is due to the Stirling engines requirement of obtaining useful power output for a given engine size. Stirling engines can operate between 50 to 200 atmospheres internal pressure; for high performance engines.

Since Stirling engines are closed cycle engines, heat must travel through the container materials to get into the working fluid. These materials typically are made as thin as possible to maximize the heat transfer rates. The combination of high pressures and temperatures has limited Stirling engine maximum temperatures to around 800° C. Ceramic materials have been investigated as a technique to allow higher temperatures, however their brittleness and high cost have made them difficult to implement.

U.S. Pat. No. 5,611,201, to Houtman, shows an advanced Stirling engine based on Stainless Steel technology. This engine has the high temperature components exposed to the large pressure differential which limits the maximum temperature to the 800° C. range. U.S. Pat. No. 5,388,410, to Momose et al., shows a series of tubes, labeled part number 22a through d, exposed to the high temperatures and pressures. The maximum temperature is limited by the combined effects of the temperature and pressure on the heating tubes. U.S. Pat. No. 5,383,334 to Kaminishizono et al, again shows heater tubes, labeled part number 18, which are exposed to the large temperature and pressure differentials. U.S Pat. No. 5,433,078, to Shin, also shows the heater tubes, labeled part number 1, exposed to the large temperature and pressure differentials. U.S Pat. No. 5,555,729, to Momose et al., uses a flattened tube geometry for the heater tubes, labeled part number 15, but is still exposed to the large temperature and pressure differential. The flat sides of the tube add additional stresses to the tubing walls. U.S Pat. No. 5,074,114, to Meijer et al., also shows the heater pipes exposed to high temperatures and pressures.

The Stirling engine disclosed in the inventor's U.S. Pat. No. 6,041,598 overcomes the limitations and shortcomings of the above prior art by providing a dual shell pressure chamber. An inner shell surrounds the heat transfer tubing and the regenerator. The portion surrounding the heat transfer tubing contains a thermally conductive liquid metal to facilitate heat transfer from a heat source to the heat transfer tubing and also to transmit external pressure to the heat transfer tubing. An outer shell that acts as a pressure vessel surrounds the inner shell and contains a thermally insulating liquid between the inner and outer shells. Pressure of the working fluid as it flows through the regenerator is transmitted through the inner shell to the insulating liquid and back across the inner shell to the liquid metal surrounding the heat transfer tubing. This system tends to balance the pressure across the heat transfer tubing and the inner shell, thereby allowing the engine to operate with the working fluid at a high pressure to generate significant power while keeping the wall of the heat transfer tubing thin to facilitate heat transfer through it.

An anticipated use of the inventor's dual shell Stirling engine is to run a 25 KW electrical generator. For that use, and others, the required power output of the engine may not be constant. Throttling of the engine is, therefore, probably necessary.

Throttling of Stirling engines is typically accomplished by varying the amount of working fluid inside the engine. With this technique a significant amount of pumping and valving hardware is required to move the working fluid. This is complicated by the high working pressures which increases the size of the pumping hardware. A second technique to throttle the Stirling engine involves opening ports within the engine which are connected to dead (non-working) volumes or reservoirs. That technique increases the total system volume which lowers the power but also results in a significant reduction in efficiency due the larger dead volume which the engine is exposed to for the entire piston stroke. Houtman and Meijer et al. disclose another throttling technique that uses a variable angle plate connected directly to each piston. Reducing the plate angle results in reduced movement of the piston, resulting in reduced power levels. That throttling technique has the disadvantage of a higher system weight due to the large loads generated when converting the wobble motion of the plate to torque.

The present invention provides a throttle for a Stirling engine which overcomes the limitations and shortcomings of the prior art.

### SUMMARY OF INVENTION

The present invention provides an apparatus and method for throttling a heat engine having a cylinder containing a working fluid with a piston moving therein. A plurality of cylinder ports through a side portion of the cylinder provide fluid communication between an interior portion of the cylinder and a reservoir area when the piston is below the cylinder ports. A throttle control device selectively opens or closes a number of the cylinder ports to allow a portion of the working fluid contained in the cylinder to move between the cylinder and the reservoir area through the cylinder ports and vary the pressure in the portion of the cylinder above the piston.

The throttle control device includes a sleeve disposed around a portion of the cylinder. The sleeve has a plurality of throttle ports through it and moves relative to the cylinder, preferably rotationally, to selectively communicate a number of the throttle ports with a number of the cylinder ports to thereby open the cylinder ports so communicated.

In one embodiment the cylinder ports are arranged in groups of vertically aligned ports and the throttle ports are arranged in groups of a stepped series of ports spaced to match the cylinder ports so that as the sleeve is rotated, an increasing number of cylinder ports are opened higher up the cylinder.

In another embodiment, with the cylinder ports also arranged in groups of vertically aligned ports, the throttle ports are arranged in groups diagonally such that as the sleeve is rotated, a single cylinder port per group of cylinder ports is opened higher up the cylinder.

In yet another embodiment, the cylinder ports are arranged in a single circumferential row around the cylinder and the throttle ports are arranged in a single circumferential row on the sleeve such that each throttle port aligns with each corresponding cylinder port. The sleeve rotates between a position that allows the cylinder ports to be fully open and a position that allows the cylinder ports to be completely closed, with variable positioning therebetween to thereby vary the amount the cylinder ports open.

The preferred mechanism for the throttle control device includes a throttle collar attached to the cylinder that supports the throttle sleeve. A throttle worm gear is attached to the throttle sleeve and is driven by a throttle control worm that engages the throttle worm gear to rotationally position the throttle sleeve about the cylinder to selectively communicate a number of the throttle ports with a number of the cylinder ports to thereby open the cylinder ports so communicated.

There is preferably a throttle fairing that surrounds the throttle control device and provides a pressure fairing to contain the working fluid passing through the cylinder ports. The throttle fairing has a series of throttle vents that provide fluid communication between the reservoir area and an area inside of the throttle fairing.

Preferably there is also a check valve in the piston which allows working fluid in the reservoir area to move through it into the interior area of the cylinder when pressure in the reservoir area exceeds that of the interior area of the cylinder.

To throttle the heat engine, the ports in the cylinder are selectively opened to allow communication between the reservoir area and the interior portion of the cylinder above the piston when the piston is below the ports. Working fluid vents from the interior portion of the cylinder through the open ports to the reservoir area as the piston moves up in the cylinder toward the open ports to prevent significant compression of the working fluid in the cylinder. The venting is stopped by blocking the open ports with the piston as the piston moves up past the ports to thereby resume compression of the working fluid in the cylinder. The pressure produced during compression of the working fluid is therefore reduced from that produced when the ports in the cylinder are closed, thereby effectively throttling the engine.

Pressure is increased again by closing the open ports and moving working fluid from the reservoir area to the interior area of the cylinder above the piston, preferably through a check valve in the piston, to restore the amount of working fluid in the interior area of the cylinder above the piston, thereby allowing higher pressures to be produced during compression of the working fluid by the piston.

The features, benefits and objects of this invention will become clear to those skilled in the art by reference to the following description, claims and drawings.

### BRIEF DESCRIPTION OF DRAWINGS

FIG. 1 is a longitudinal vertical cross sectional view showing the overall arrangement for a complete dual shell Stirling engine.

FIG. 2 is a side elevational view of a section of the cylinder in the region of the throttle showing the ports through the cylinder.

FIG. 3 is a side elevational view of the throttle sleeve, throttle worm gear and throttle control worm.

FIG. 4 is the view of FIG. 2 showing another embodiment for the configuration of the ports.

FIG. 5 is the view of FIG. 3 showing another embodiment of the throttle sleeve corresponding to the port configuration showing FIG. 4.

FIG. 6 is a cross sectional view of a portion of the cylinder and throttle sleeve at a port when the throttle sleeve is positioned such that the port is open.

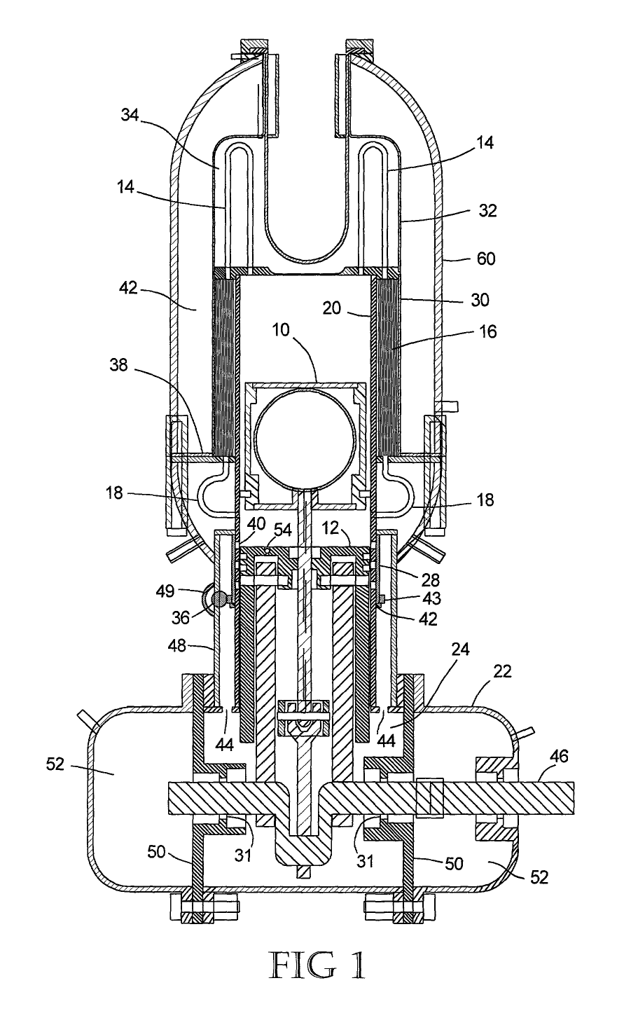

### DETAILED DESCRIPTION

In the following description of the invention, the components are illustrated and described in a vertical orientation with the cylinder located above the lower housing. Terms such as upper, lower, above and below are used to describe the relative positions of components and are not intended to indicate a quality or locational requirement since the cylinder can be oriented in any position relative to the housing and crankshaft.

Referring to FIG. 7, components of a dual shell Stirling engine having a power piston 12 that drives an output crankshaft 46 are illustrated. A working fluid, such as Helium, is contained in cylinder 20 above power piston 12 and is shuttled through heat transfer tubing 14, regenerator 16, and cooling pipes 18 by the action of a displacer piston 10. An inner shell 30 surrounds the heat transfer tubing 14 and regenerator 16. The upper portion 32 of inner shell 30 contains a liquid metal region 34 filled with a thermally conductive liquid metal, such as silver, which surrounds the heat transfer tubing 14. The regenerator 16 is preferably a coiled annulus of thin material disposed between cylinder 20 and inner shell 30. Outer shell 60 surrounds inner shell 30 and acts as a pressure vessel. The inner shell 30, outer shell 60 and flange 38 bound a pressure backup region 42. The pressure backup region is filled preferably with an insulating liquid material to provide pressure backup against inner shell 30 and, consequently through liquid metal region 34, to heat transfer tubing 14.

Lower housing 22 has a reservoir area 24 between a pair of crankshaft end plates 50 which acts as a reservoir for the working fluid and is in fluid communication with the working fluid in cylinder 20 through throttle ports 40 in cylinder 20. Low pressure seals and bearings 31 prevent the working fluid in reservoir area 24 from escaping into the space 52 outside of crankshaft end plates 50, which is preferably pressurized with ambient air to approximately the same pressure as that in reservoir area 24. Throttling is accomplished by controlling the openings of throttle ports 40 in cylinder 20.

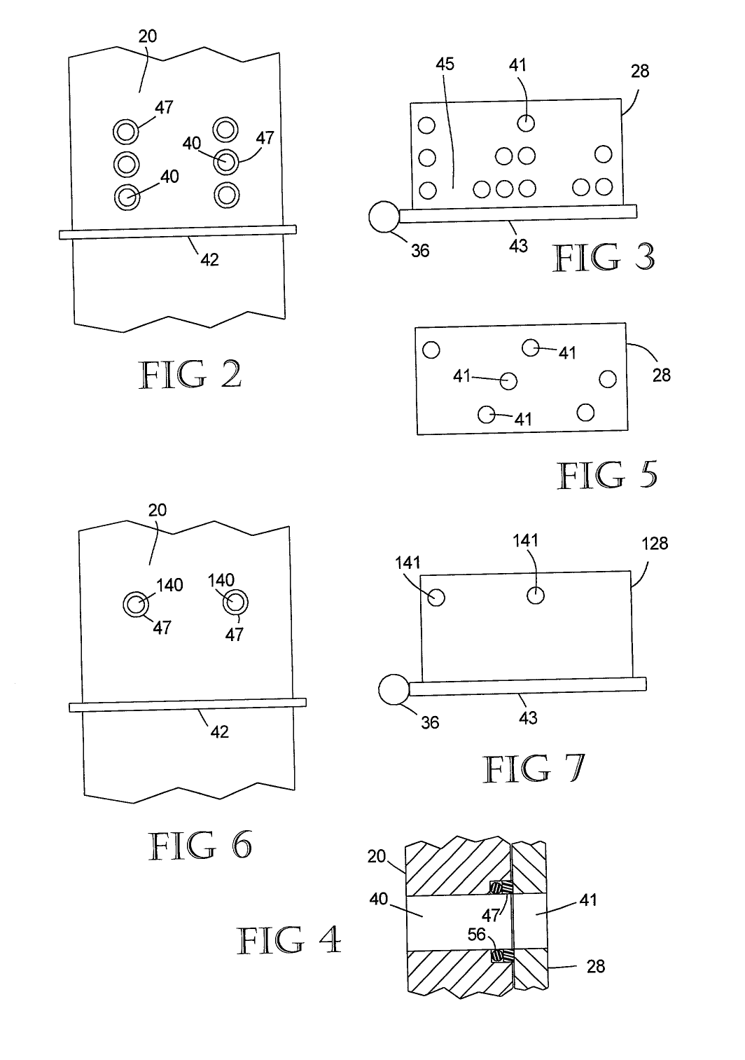

Referring also to FIG. 2, a portion of cylinder 20 adjacent to throttle sleeve 28 has a series of cylinder ports 40 drilled into its side so that when the power piston 12 is at bottom dead center, the cylinder ports 40 are completely above the power piston 12 and allow fluid communication between the area inside cylinder 20 above power piston 12 and the reservoir area 24 in lower housing 22. Open cylinder ports 40 allow the working fluid in cylinder 20 to vent to reservoir area 24 as the power piston 12 rises, thus preventing compression in the region above the power piston 12. As the power piston 12 moves up cylinder 20 beyond cylinder ports 40, the region above the power piston 12 is sealed and compressed. The start of the sealing is dependent on the throttle port sequence determined by the throttle control device as follows.

Cylinder ports 40 are arranged in groups circumferentially around cylinder 20. Each group has a plurality of vertically oriented ports 40, preferably three ports per group. Referring also to FIG. 3, throttle sleeve 28 has groupings of throttle ports 41 arranged so as to provide a stepped series of ports spaced vertically to match the cylinder ports 40 in cylinder 20. A blank portion 45 separates each grouping of throttle ports 41 around the throttle sleeve 28. The throttle sleeve 28 fits around the cylinder 20 with a snug fit so as to provide a seal between the throttle sleeve 28 and the cylinder 20, but loose enough that the throttle sleeve 28 can move relative to cylinder 20. Sealing around ports 40 is accomplished by washers 47, preferably made of material such as Teflon, which are installed in a countersunk area around ports 40 such that the tops of the washer extend slightly beyond the outer surface of cylinder 20. FIG. 4 illustrates the relationship between washer 47, cylinder 20 and sleeve 28. Compressibility of washer 47 is preferably provided by a resilient O-ring 56 behind washer 47.

The throttle control device functions preferably by rotating throttle sleeve 28 around the cylinder 20 through the distance of each grouping of throttle ports 41. There may be other configurations for sleeve 28 and throttle ports 41 that may allow sleeve 28 to move axially, or a combination of axially and rotationally, rather than rotate to accomplish a similar result, but the preferred motion of sleeve 28 is simple rotation around cylinder 20. When the blank portion 45 covers cylinder ports 40, throttle sleeve 28 provides a complete seal and a full-throttle condition. As the throttle sleeve 28 is rotated, an increasing number of throttle ports 41 communicate with cylinder ports 40 higher up cylinder 20 which allow the working fluid to vent from the area above the power piston 12 into the throttle housing 48 and to reservoir area 24. The higher the cylinder ports 40, the more power piston 12 has to travel without significantly compressing the working fluid in the cylinder 20. Once the power piston 12 moves past the open cylinder ports 40, the compression continues in the cylinder 20; but since there is less working fluid in cylinder 20, the pressure produced by the compression is reduced. This reduction in pressure reduces the total power produced, and effectively throttles the engine. It is also possible that only one cylinder port 40 per group need be opened at a time to allow adequate venting. In that case, the throttle ports 41 for each grouping on throttle sleeve 28 could be arranged diagonally such as is illustrated in FIG. 5.

Referring again to FIG. 7, once the throttle sleeve 28 is rotated to a higher throttle position, thereby covering more cylinder ports 40, at the bottom of the stroke of power piston 12, the pressure in cylinder 20 above power piston 12 would be less than that in reservoir area 24 and some of the working fluid in reservoir area 24 flows back into the cylinder through a check valve 54, preferably in the top of power piston 12, to re-pressurize cylinder 20 until the average pressures are equalized. In steady-state operation, when the power piston 12 is at the bottom of its stroke, the pressure in cylinder 20 above power piston 12 equals that in reservoir area 24 and there is no significant movement of the working fluid through check valve 54.

A throttle fairing 48 and throttle fairing blister 49 provide a pressure fairing for the throttle sleeve 28 to contain the working fluid. The throttle fairing 48 has a series of throttle vents 44 located at the lower side of the throttle fairing 48 on the surface of the lower housing 22. The throttle vents 44 provide a means for the working fluid, preferably Helium, to move from the cylinder 20 into the reservoir area 24 of lower housing 22.

As throttle sleeve 28 rotates about cylinder 20, it is supported by a throttle collar 42 attached to the outside of cylinder 20. The throttle control device includes a throttle worm gear 43 attached to the throttle sleeve 28 and a throttle control worm 36 that engages the throttle worm gear 43 and drives it to rotationally position the throttle sleeve 28. The combination of the throttle control worm 36 and the throttle worm gear 43 provide a means to reduce the gearing to improve the positioning accuracy of the throttle sleeve 28. It is possible to control motion of throttle sleeve 28 such that only portions of cylinder ports 40 are opened, thereby providing even finer throttle control.

Referring to FIGS. 6 and 7, another embodiment for the throttle has only a single cylinder port 140 at each circumferential location rather than a group of vertically oriented ports. The single circumferential row of ports 140 is preferably at approximately the same location as the uppermost port of the groups of ports 40 illustrated in FIG. 2. Throttle sleeve 128 has a corresponding series of single throttle ports 141 circumferentially arranged around it that match the locations of the cylinder ports 140. The fine positional control of throttle sleeve 128 allows the sleeve to rotate between a position that allows the cylinder ports 140 to be fully open and a position that allows the cylinder ports 140 to be completely closed, with variable positioning therebetween to thereby vary the amount the cylinder ports 140 open. This effectively creates a variable orifice at each port. The amount of working fluid that vents through ports 140 is dependent on how open ports 140 are and the speed of the engine. Higher rpm as well as smaller openings reduce the amount of working fluid that vents.

A feature of the throttling system of the present invention is the complete sealing of the upper cylinder region after the power piston 12 has passed the cylinder ports 40. The advantage of this is that the engine will operate at a much higher efficiency at partial power than with a dead-volume throttling system which maintains the increased dead volume over the complete stroke. The reason for this improvement is tied into the Stirling cycle and its working fluid movement. The working fluid above the power piston 12 gets shuttled between the area above and the area below the displacer piston 10 during each cycle. During the power stroke the majority of the working fluid is heated and located above the displacer piston 10. As the power piston 12 gets pushed downward, an increase in volume occurs between the displacer piston 10 and the power piston 12. This results in movement of the working fluid from the region above the displacer piston 10 to the region below it. With the old dead-volume system, a reservoir is connected to the flow path of the working fluid as it shuttles between those locations. The total amount of working fluid in the area above the power piston and in the dead volume does not change. Therefore, when the working fluid moves during the power stroke, part of the fluid remains in the region above the power piston and does useful work and part of the fluid expands into the dead volume chamber and does useless work. This extra quantity of wasted work reduces the total engine efficiency.

Rather than providing a dead volume on the flow path of the working fluid above the power piston, the present invention reduces the amount of working fluid present in the cylinder above the power piston 12. On the compression stroke, until the ports are closed by the power piston the extra reservoir area volume reduces the compression and, thus, the amount of working fluid above the power piston. On the power stroke, all of the working fluid (though reduced in amount) moves to the region below the displacer piston 10 and expands against the power piston 12 doing useful work until the throttle ports open up again. A small amount of work is wasted when the throttle ports are opened by the power piston and the remaining compression is released into the reservoir area. The present invention thus reduces the amount of wasted work, thereby improving the throttle efficiency.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims.

1. A throttle for a heat engine having a cylinder containing a working fluid with a piston moving therein, comprising:
a plurality of cylinder ports through a side portion of the cylinder, the cylinder ports providing fluid communication between an interior portion of the cylinder and a reservoir area when the piston is below the cylinder ports; and
a throttle control device which selectively opens or closes a number of the cylinder ports to allow a portion of the working fluid contained in the cylinder to move between the cylinder and the reservoir area through the cylinder ports to vary pressure in a portion of the cylinder above the piston.

2. The throttle of claim 1, wherein the throttle control device includes a sleeve disposed around a portion of the cylinder, the sleeve having a plurality of throttle ports through it, the sleeve moving relative to the cylinder to selectively communicate a number of the throttle ports with a number of the cylinder ports to thereby open the cylinder ports so communicated.

3. The throttle of claim 2, wherein the and sleeve rotates about the cylinder.

4. The throttle of claim 3, wherein the cylinder ports are arranged in groups of vertically aligned ports.

5. The throttle of claim 4, wherein the throttle ports are arranged in groups of a stepped series of ports spaced to match the cylinder ports so that as the sleeve is rotated, an increasing number of cylinder ports are opened higher up the cylinder.

6. The throttle of claim 4, wherein the throttle ports are arranged in groups diagonally such that as the sleeve is rotated a single cylinder port per group of cylinder ports is opened higher up the cylinder.

7. The throttle of claim 3, wherein the cylinder ports are arranged in a single circumferential row around the cylinder.

8. The throttle of claim 7, wherein the throttle ports are arranged in a single circumferential row such that each throttle port aligns with each corresponding cylinder port.

9. The throttle of claim 8, wherein the sleeve rotates between a position that allows the cylinder ports to be fully open and a position that allows the cylinder ports to be completely closed, with variable positioning therebetween to thereby vary the amount the cylinder ports open.

10. The throttle of claim 3, wherein the throttle control device includes a throttle collar attached to the cylinder, the throttle collar supporting the throttle sleeve as it rotates about the cylinder.

11. The throttle of claim 3, wherein the throttle control device includes a throttle worm gear attached to the throttle sleeve and a throttle control worm that engages the throttle worm gear and drives it to rotationally position the throttle sleeve.

12. The throttle of claim 1, further comprising a throttle fairing that surrounds the throttle control device and provides a pressure fairing to contain the working fluid passing through the cylinder ports.

13. The throttle of claim 12, wherein the throttle fairing has a series of throttle vents that provide fluid communication between the reservoir area and an area inside of the throttle fairing.

14. The throttle of claim 1, further comprising a check valve in the piston which allows working fluid in the reservoir area to move through it into the interior area of the cylinder when pressure in the reservoir area exceeds that of the interior area of the cylinder.

15. A throttle for a heat engine having a cylinder containing a working fluid with a piston moving therein, comprising:
a plurality of cylinder ports through a side portion of the cylinder, the cylinder ports providing fluid communication between an interior portion of the cylinder and a reservoir area when the piston is below the cylinder ports; and
a sleeve disposed around a portion of the cylinder, the sleeve having a plurality of throttle ports through it, the sleeve rotating relative to the cylinder to selectively communicate a number of the throttle ports with a number of the cylinder ports to thereby open the cylinder ports so communicated to allow a portion of the working fluid contained in the cylinder to move between the cylinder and the reservoir area through the cylinder ports to vary pressure in a portion of the cylinder above the piston.

16. A throttle for a heat engine having a cylinder containing a working fluid with a piston moving therein, comprising:
a plurality of cylinder ports through a side portion of the cylinder, the cylinder ports providing fluid communication between an interior portion of the cylinder and a reservoir area when the piston is below the cylinder ports;
a sleeve disposed around a portion of the cylinder, the sleeve having a plurality of throttle ports through it;
a throttle collar attached to the cylinder, the throttle collar supporting the throttle sleeve;
a throttle worm gear attached to the throttle sleeve; and
a throttle control worm that engages the throttle worm gear and drives it to rotationally position the throttle sleeve about the cylinder to selectively communicate a number of the throttle ports with a number of the cylinder ports to thereby open the cylinder ports so communicated to allow a portion of the working fluid contained in the cylinder to move between the cylinder and the reservoir area through the cylinder ports to vary pressure in a portion of the cylinder above the piston.

17. A method of throttling a heat engine having a cylinder containing a working fluid with a piston moving therein and a reservoir area for the working fluid, the reservoir area communicating with an interior portion of the cylinder through ports in the cylinder, the method comprising the steps of:
selectively opening ports in the cylinder to allow communication between the reservoir area and the interior portion of the cylinder above the piston when the piston is below the ports;
venting working fluid from the interior portion of the cylinder through the open ports to the reservoir area as the piston moves up in the cylinder toward the open ports to prevent significant compression of the working fluid in the cylinder; and
stopping the venting by blocking the open ports with the piston as the piston moves up past the ports to thereby resume compression of the working fluid in the cylinder,
whereby the pressure produced during compression of the working fluid is reduced from that produced when the ports in the cylinder are closed, thereby effectively throttling the engine.

18. The method of claim 17, whereby the ports in the cylinder are selectively opened or closed by moving a sleeve disposed around the cylinder between a position where the ports are covered and a position where the ports are opened.

19. The method of claim 17, further comprising the subsequent steps of:
selectively closing the open ports; and
moving working fluid from the reservoir area to the interior area of the cylinder above the piston through a check valve to restore the amount of working fluid in the interior area of the cylinder above the piston, thereby allowing higher pressures to be produced during compression of the working fluid by the piston.
